(19) United States
(12) Patent Application Publication
(10) Pub. No.: US 2008/0150942 A1
(43) Pub. Date: Jun. 26, 2008

(54) Visualization of volumetric medical imaging data

(75) Inventors: Ross Mitchell, Calgary (CA); Torin Taerum, Calgary (CA); Jonathan Neil Draper, Calgary (CA); Pierre Josepth Lemire, Calgary (CA)

Correspondence Address: FREEDMAN & ASSOCIATES, 117 CENTREPOINTE DRIVE, SUITE 350, NEPEAN, ONTARIO, K2G 5X3, omitted

(73) Assignee: Calgary Scientific Inc., Calgary, Alberta (CA)

(21) Appl. No.: 11/907,444

(22) Filed: Oct. 12, 2007

Related U.S. Application Data
(60) Provisional application No. 60/851,299, filed on Oct. 13, 2006.

(51) Int. Cl. G06T 17/00

(52) U.S. Cl. 345/424

(57) ABSTRACT

The present invention relates to a method for visualizing a volumetric medical imaging data set indicative of at least a vessel being imaged using a contrast agent. A first and a second range of intensity values of voxels of the volumetric medical imaging dataset are determined. The first range of intensity values is indicative of a wall of the at least a vessel and the second range of intensity values is indicative of the contrast agent. For a following silhouette rendering process a silhouette decay value is determined such that the vessel walls and the contrast agent are simultaneously visible. The visualization of the volumetric medical imaging data set such that the vessel walls and the contrast agent are simultaneously visible substantially facilitates the diagnosis of a blockage in a vessel.

This application claims the benefit of United States Provisional Patent Application No. 60/851,299 filed Oct. 13, 2006, the entire contents of which are incorporated herein by reference.

### FIELD OF THE INVENTION

This invention relates to visualization of volumetric data and in particular to a data processing method for rendering volumetric medical imaging data for displaying vessels.

### BACKGROUND OF THE INVENTION

Cardio-vascular and cerebral-vascular disease are the number 1 cause of death and disability in North America and most European countries. Cardio-vascular and cerebral-vascular disease are caused by a narrowing of arteries—arterial stenosis—due to atherosclerotic plaques—fatty deposits on the blood vessel wall. When blockages are severe enough, the blood flow to a portion of the heart or brain is restricted resulting in cardiac ischemia or cerebral ischemia, respectively. Ultimately, when the blood flow is blocked substantially or completely, affected portions of the heart muscle tissue or brain tissue die—heart attack or stroke, respectively—resulting in death or severe disability of a patient.

Another potentially life threatening or disabling disease is pulmonary embolism due to the blockage of an artery in the lungs. A common form of pulmonary embolism is a thrombo-embolism, which occurs when a blood clot dislodges from its site of formation and embolizes in the arterial blood supply of one of the lungs.

In peripheral artery disease, obstruction occurs in the arteries of arms and legs resulting initially in pain—during temporary obstruction—and finally in tissue death and gangrene if not treated.

Modern medical imaging systems such as Magnetic Resonance Imagers (MRI) and Computed Tomography (CT) produce volumetric datasets providing a clinical practitioner with substantially more information by allowing viewing of an imaged region of a patient's body from various viewing directions. For example, the 3D reconstruction of computed tomograms has been found particularly useful for visualizing blood vessels.

Increasing availability of powerful workstations has fueled the development of new methods for visualizing a volumetric dataset—commonly represented by a 3D grid of volume elements or voxels. The process of presenting a volumetric dataset from a given viewpoint is commonly referred to as volume rendering, and is one of the most common techniques for visualizing a 3D object or phenomenon represented by voxels at the grid points of the volumetric dataset.

A state of the art visualization of blood vessels based on volumetric rendering is disclosed in D. Ruijters, D. Babic, B. M. ter Haar Romeny, and P. Suetens: “Silhouette Fusion of Vascular and Anatomical Volume Data”, Proc. ISBI, 2006. This state of the art technique provides contextual information for locating blood vessels by combining data sets obtained from 3D angiography and CT or MR. However, this technique as well as other state of the art visualization techniques visualize blood vessels as solid tubular structures indicative of contrast agent used in the angiography.

Unfortunately, using state of the art visualization techniques it is very difficult and requires a substantial amount of experience to detect some types of blockages in a blood vessel.

It would be highly desirable to overcome the drawbacks of the state of the art by providing a method for rendering volumetric medical imaging data for displaying vessels such that detection of some types of blockages in a blood vessel is substantially facilitated.

### SUMMARY OF THE INVENTION

It is, therefore, an object of embodiments of the invention to provide a method for rendering volumetric medical imaging data for displaying vessels such that detection of some types of blockages in a blood vessel is substantially facilitated.

In accordance with the present invention there is provided a method for visualizing a volumetric medical imaging dataset comprising:

receiving the volumetric medical imaging dataset, the volumetric medical imaging dataset being indicative of at least a vessel being imaged using a contrast agent;
providing a first and a second range of intensity values of voxels of the volumetric medical imaging dataset, the first range of intensity values being indicative of a wall of the at least a vessel and the second range of intensity values being indicative of the contrast agent;
providing a transfer function for mapping one of colors and grey scale levels to the determined first and second range of intensity values;
providing a silhouette decay value such that the vessel walls and the contrast agent are simultaneously visible;
rendering the volumetric medical imaging dataset using a first silhouette rendering process in dependence upon the transfer function and the silhouette decay value;
receiving data indicative of a first viewing direction;
generating first vessel display data by processing the rendered volumetric medical imaging dataset in dependence upon the data indicative of a first viewing direction; and,
using a graphical display, displaying the first vessel display data.

In accordance with the present invention there is further provided a method for visualizing a volumetric medical imaging dataset comprising:

receiving the volumetric medical imaging dataset, the volumetric medical imaging dataset being indicative of at least a vessel;
providing a range of intensity values of voxels of the volumetric medical imaging dataset, the range of intensity values being indicative of a wall of the at least a vessel;
providing a transfer function for mapping one of colors and grey scale levels to the determined range of intensity values;
providing a silhouette decay value such that the vessel walls are visualized at least partially in a transparent fashion; and,
rendering the volumetric medical imaging dataset using a first silhouette rendering process in dependence upon the transfer function and the silhouette decay value, wherein vessel walls are visible within the rendered volumetric medical imaging dataset.

In accordance with the present invention there is yet further provided a storage medium having stored therein executable commands for execution on a processor, the processor when executing the commands performing:

receiving the volumetric medical imaging dataset, the volumetric medical imaging dataset being indicative of at least a vessel being imaged using a contrast agent;
receiving a first and a second range of intensity values of voxels of the volumetric medical imaging dataset, the first range of intensity values being indicative of a wall of the at least a vessel and the second range of intensity values being indicative of the contrast agent;
determining a transfer function for mapping one of colors and grey scale levels to the determined first and second range of intensity values;
receiving a silhouette decay value such that the vessel walls and the contrast agent are simultaneously visible;
rendering the volumetric medical imaging dataset using a first silhouette rendering process in dependence upon the transfer function and the silhouette decay value;
receiving data indicative of a first viewing direction;
generating first vessel display data by processing the rendered volumetric medical imaging dataset in dependence upon the data indicative of a first viewing direction; and,
providing the first vessel display data.

### BRIEF DESCRIPTION OF THE FIGURES

Exemplary embodiments of the invention will now be described in conjunction with the following drawings, in which:

FIG. 1 is a simplified flow diagram illustrating a method for visualizing a volumetric medical imaging dataset according to the invention;

FIG. 2 is a diagram illustrating a histogram for determining a first range and a second range of intensity values in the method for visualizing a volumetric medical imaging dataset according to the invention;

FIGS. 3, 4, and 5 are diagrams illustrating cerebral blood vessels using the method for visualizing a volumetric medical imaging dataset according to the invention with a low, high, and medium-low silhouette decay value, respectively;

FIG. 6 is a simplified block diagram illustrating a system visualizing a volumetric medical imaging dataset according to the invention;

FIGS. 7a and 7b are diagrams illustrating cerebral blood vessels using a standard CT rendering process and the method for visualizing a volumetric medical imaging dataset according to the invention, respectively;

FIG. 8 is a simplified flow diagram illustrating another method for visualizing a volumetric medical imaging dataset according to the invention; and,

FIG. 9 is a diagram illustrating cerebral blood vessels using the other method for visualizing a volumetric medical imaging dataset according to the invention.

### DETAILED DESCRIPTION OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

In the following, it will become apparent to those skilled in the art that the invention, while being described in context with detection of a blockage in a blood vessel—cerebral artery—as an example, it is not limited thereto. There are numerous other beneficial applications of the invention such as visualization of numerous other blood vessels, for example, coronary, pulmonary, and peripheral arteries, as well as other types of vessels such as, for example, esophagus, intestine, colon, ureter, bladder, and urethra.

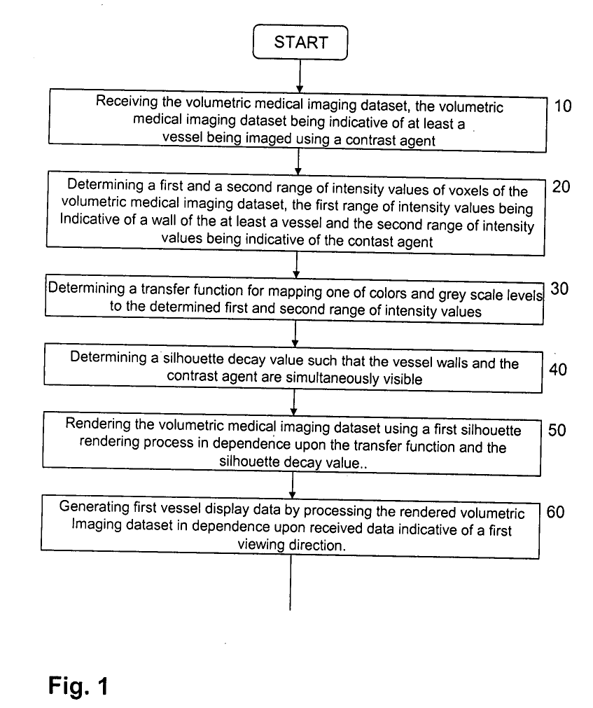

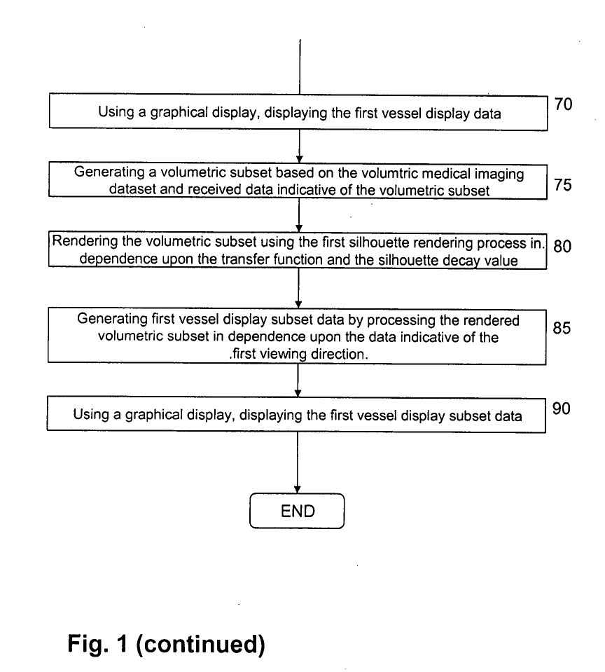

Referring to FIG. 1, a simplified flow diagram of a method for visualizing a volumetric medical imaging dataset according to the invention is shown. At 10, the volumetric medical imaging dataset is received, for example, at a processor of a workstation. The received volumetric medical imaging data set comprises, for example, a 3D array of voxels indicative of at least a vessel imaged using a contrast agent. For example, the volumetric medical imaging data set is received from a MR Angiography (MRA) system or a CT Angiography (CTA) system used for imaging cerebral blood vessels.

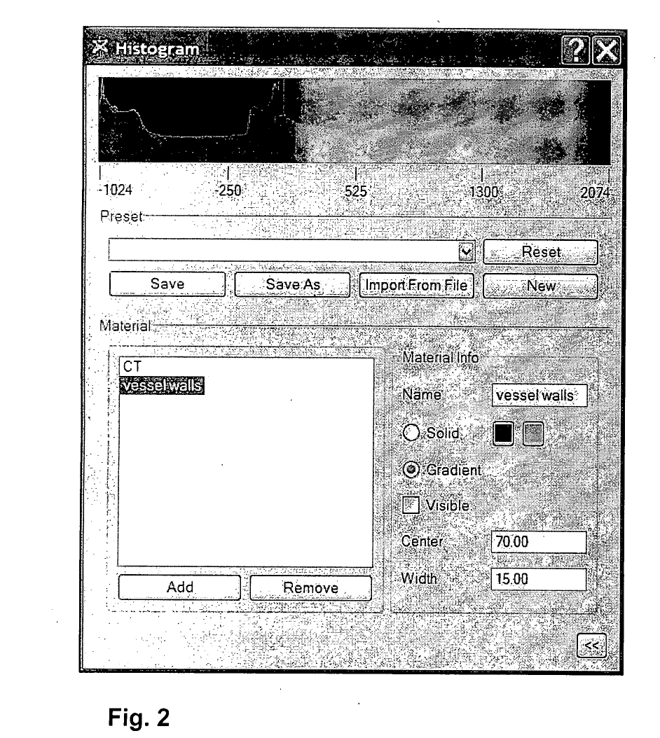

At 20, a first and a second range of intensity values of the voxels of the volumetric medical imaging dataset are determined. The first range of intensity values is indicative of a vessel wall, for example, the wall of a cerebral artery, while the second range of intensity values is indicative of the contrast agent. The first range of intensity values is determined as a narrow band of intensity values, for example, expressed as a narrow band of Hounsfield units. For example, in order to facilitate the determination of the first and the second range of intensity values, a histogram of the intensity values of the voxels of the volumetric medical imaging dataset is determined using the processor and displayed, for example, in a graphical fashion as a 2D array using a graphical display, as shown in FIG. 2. The histogram represents range and distribution of signal intensities for individual voxels of the volumetric medical imaging dataset. For example, when viewing a CT data set, tissues with a high density, such as bone, correspond to the upper range of histogram values whereas lower-density tissues, such as skin, correspond to the lower range of histogram values. Using such a display of the histogram a user is able to determine the first and the second range of intensity values by selecting corresponding areas in the histogram. Based on the selected areas user interface range input data are then provided to the processor. Optionally, using the processor a preset first and second range of intensity values are determined and, for example, displayed in a graphical fashion in the displayed histogram. Determining and displaying the preset first and second range of intensity values is very helpful by providing guidance to the user in order to start the visualization process. For example, the user initiates execution of a first visualization using the preset values and after having judged the first visualization modifies the preset first and second range of intensity values for a second—optimized—visualization. The preset first and second range of intensity values are, for example, determined in an empirical fashion based on previously determined ranges. Alternatively, the preset first and second range of intensity values are determined based on parameters of the imaging system used for generating the volumetric medical imaging dataset, parameters indicative of an absorption of radiation in the contrast agent and the tissue of the vessel walls.

At 30, using the processor a transfer function is determined for mapping one of colors and grey scale values to the determined first and second range of intensity values. For example, the one of colors and grey scale values are selected by a user after determining the first and second range of intensity values and user interface transfer function data are provided to the processor via the user interface. Alternatively, the one of colors and grey scale values are preset in order to minimize user interaction.

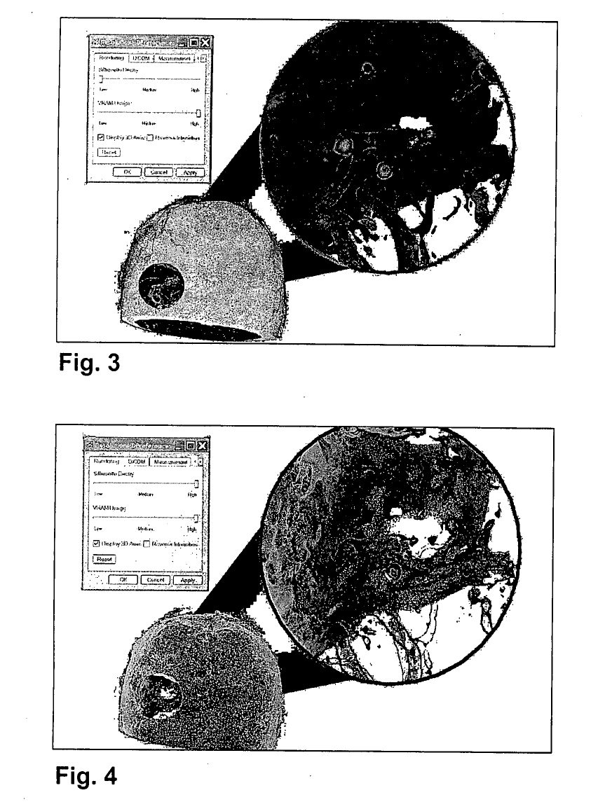

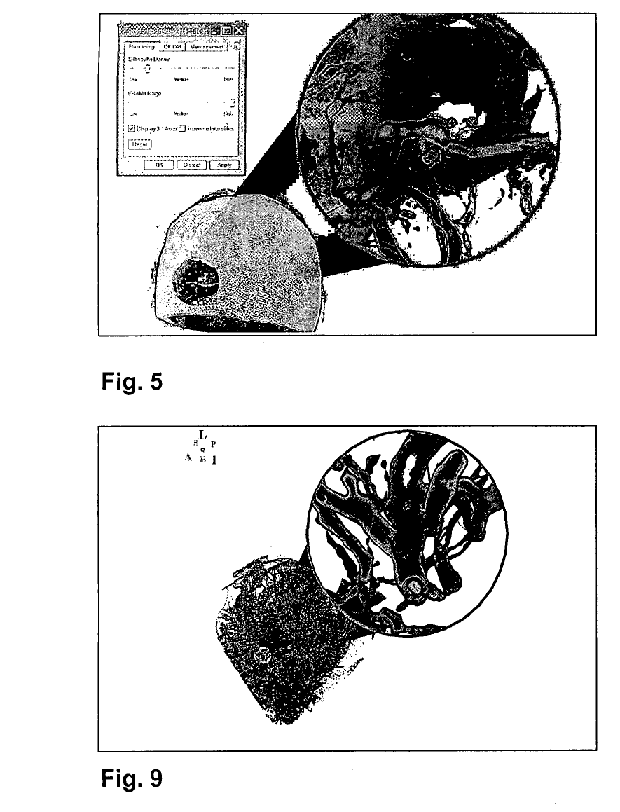

For the visualization a silhouette rendering process is applied in order to visualize the volumetric medical imaging dataset such that the vessel walls and the contrast agent are simultaneously visible. In the silhouette rendering process a predetermined decay is applied. When the decay value is too low, the vessel walls are not visualized in a transparent fashion, i.e. the outside surface of the vessels are visualized in a solid fashion, as shown in FIG. 3. On the other hand, when the decay value is too high, portions of the contrast agent and the vessel walls are no longer visible, as shown in FIG. 4. Therefore, at 40, a suitable silhouette decay value for the silhouette rendering process is determined such that the vessel walls and the contrast agent are simultaneously visible, as shown in FIG. 5. For example, the silhouette decay value is selected by a user and silhouette decay value input data are provided to the processor via the user interface. Alternatively, the one of colors and grey scale values are preset in order to minimize user interaction. Optionally, using the processor a preset silhouette decay value is determined and, for example, displayed. Determining and displaying the preset silhouette decay value is very helpful by providing guidance to the user in order to start the visualization process. For example, the user initiates execution of a first visualization using the preset values and after having judged the first visualization modifies the preset silhouette decay value for a second—optimized—visualization. The preset silhouette decay value is, for example, determined in an empirical fashion based on previously silhouette decay values.

The above provision of preset values for the first and second range of intensity values, the transfer function, and the silhouette decay value is highly advantageous in emergency situations by visualizing the volumetric medical imaging dataset such that the vessel walls and the contrast agent are simultaneously visible and of sufficient quality to enable a user to detect a blockage in a blood vessel while minimizing the time needed to produce the visualization by minimizing user interaction.

At 50, the volumetric medical imaging dataset is then rendered using the silhouette rendering process with the above determined transfer function and silhouette decay value. For example, the silhouette rendering process is executed as a gradient rendering process using off-the-shelf Graphics Processing Units (GPU) on a personal computer or workstation.

A user is then enabled to select a first viewing direction. Upon receipt of data indicative of the first viewing direction the processor generates—at 60—first vessel display data by processing the rendered volumetric medical imaging dataset in dependence upon the data indicative of the first viewing direction which are then displayed—at 70—using a graphical display. Optionally, the first vessel display data are generated such that they contain graphical data indicative of luminance of at least one of the vessel walls and the contrast agent. For example, the graphical data indicative of luminance are generated such that the luminance changes with depth of a location of the least one of the vessel walls and the contrast agent within the volumetric medical imaging dataset in the first viewing direction, providing a user with a better depth orientation of the vessels. Further optionally, other graphical data are generated such as, for example, data indicative of shading.

Of course, a user is able to change the viewing direction, for example, by rotating the volumetric medical imaging dataset, i.e. upon receipt of data indicative of a second viewing direction the processor generates second vessel display data by processing the rendered volumetric medical imaging dataset in dependence upon the data indicative of the second viewing direction which are then displayed using the graphical display.

Furthermore, a user is able to determine a volumetric subset of the volumetric medical imaging dataset in order to focus on a specific location. For example, the user having a look at the visualization of the volumetric medical imaging dataset finds a Region Of Interest (ROI) where he suspects a blockage in a blood vessel. He then determines a volumetric subset comprising the ROI. Upon receipt of data indicative of a volumetric subset the processor generates—at 75—the volumetric subset based on the volumetric medical imaging dataset and the data indicative of the volumetric subset. Using the processor, the volumetric subset is then rendered—at 80—using the above silhouette rendering process with the above transfer function and silhouette decay value, followed by the generation of first vessel display subset data—at 85—in dependence upon, for example, the data indicative of the first viewing direction. Using the graphical display the first vessel display subset data are displayed—at 90—for example, simultaneously with the first vessel display data in a predetermined close-up area. At this point, the user is able to change the viewing direction of the volumetric subset, for example, by rotating the volumetric subset, in order to further examine the ROI. Being able to change the viewing direction of the vessel walls and the contrast agent in the ROI substantially facilitates the diagnosis of a blockage in a vessel.

Yet further, the method for visualizing a volumetric medical imaging dataset according to the invention also allows rendering of the volumetric medical imaging dataset and the volumetric subset using different rendering processes. For example, the volumetric medical imaging dataset is rendered using another type of rendering process—for example, a standard rendering process for CT scans—while the volumetric subset is rendered using the above silhouette rendering process. This provides another type of visualization of the volumetric medical imaging dataset. In some situations this is helpful by providing contextual information.

Further optionally, the method for visualizing a volumetric medical imaging dataset according to the invention is also implementable with various other graphical tool functions—for example, clipping—to enhance visualization and/or facilitate navigation.

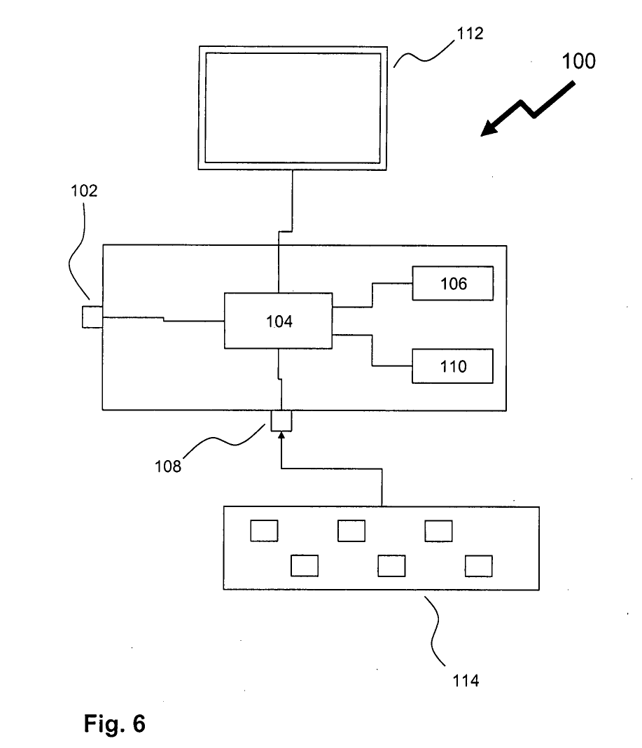

Referring to FIG. 6, a processing system 100 according to the invention for implementing the above method for visualizing a volumetric medical imaging dataset is shown. A volumetric medical imaging dataset is received at input port 102. Using electronic circuitry such as a processor 104 the dataset is then digitally processed. The system 100 comprises a storage medium 110 having stored therein executable commands for execution on the processor 104 for performing the processing corresponding to the above method. Alternatively, the processor 104 comprises electronic circuitry designed for performing at least a portion of the processing in a hardware implemented fashion. The system 100 further comprises memory 106 such as RAM in communication with the processor 104 for storing data during execution. The processing is controlled by a user viewing, for example, a graphical representation of the rendered data and by providing control commands via port 108—connected, for example, to a keyboard 114—to the processor 104. Optionally, the display 112 is a graphical user interface facilitating user interaction during processing.

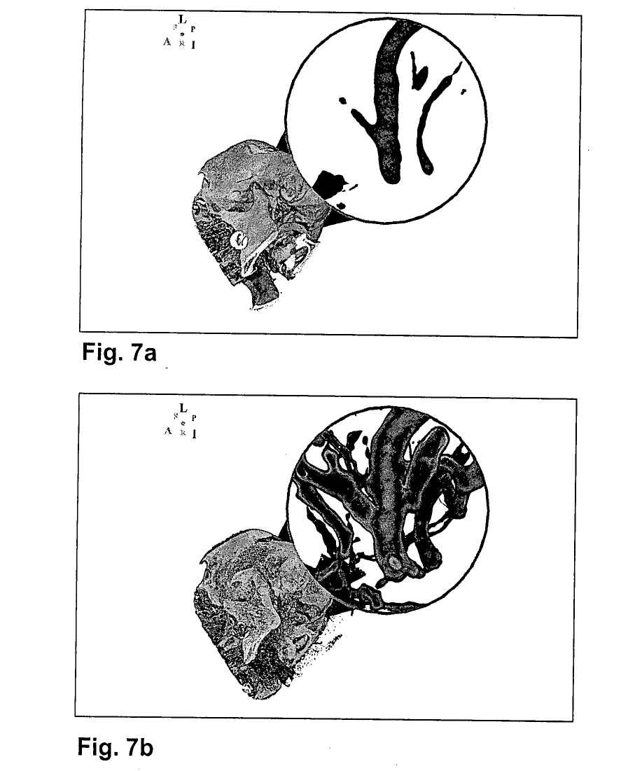

The above method for visualizing a volumetric medical imaging dataset according to the invention substantially facilitates diagnosis of a blockage of a blood vessel by simultaneously displaying the blood vessel walls and the contrast agent. FIG. 7a is a visualization of a Middle Cerebral Artery (MCA) using a standard CT rendering process. In the close-up visualization an experienced medical practitioner will notice a protrusion on the left hand side of the lower third of the visualized portion of the MCA indicating that there might be a blockage.

FIG. 7b illustrates the same view and close-up but with the dataset being rendered using the method for visualizing a volumetric medical imaging dataset according to the invention. The ability to simultaneously display the contrast agent and the vessel walls clearly indicates that the protrusion is a completely blocked branch vessel. Of course, the method for visualizing a volumetric medical imaging dataset according to the invention is not limited to the visualization of cerebral arteries but also beneficially applicable for the visualization of other blood vessels such as, for example, coronary, pulmonary, and peripheral arteries, as well as other types of vessels such as, for example, esophagus, intestine, colon, ureter, bladder, and urethra. Furthermore, the method for visualizing a volumetric medical imaging dataset according to the invention is not only beneficial for detecting blockages but also for detecting states of abnormal narrowing of vessels—stenosis—and for the determination of the size of a rupture of a vessel, for example, an aneurism.

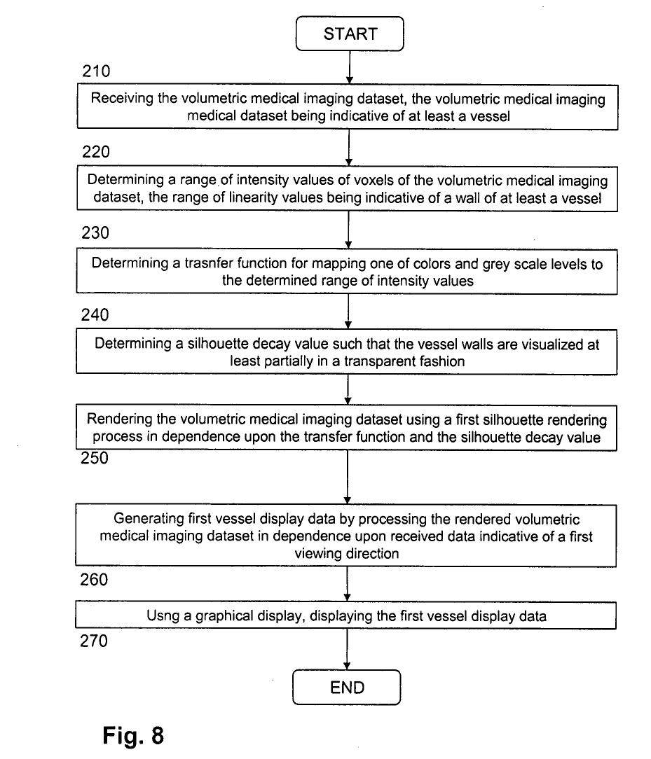

Referring to FIG. 8, a simplified flow diagram of another method for visualizing a volumetric medical imaging dataset according to the invention is shown. At 210, the volumetric medical imaging dataset is received, for example, at a processor of a workstation. The received volumetric medical imaging data set comprises, for example, a 3D array of voxels indicative of at least a vessel imaged using a contrast agent. Alternatively, no contrast agent has been used in the imaging process. At 220, a range of intensity values of the voxels of the volumetric medical imaging dataset is determined with the range being indicative of a vessel wall. At 230, using the processor a transfer function is determined for mapping one of colors and grey scale values to the determined first and second range of intensity values. For example, the one of colors and grey scale values are selected by a user after determining the range of intensity values and user interface transfer function data are provided to the processor via the user interface. Alternatively, the one of colors and grey scale values are preset in order to minimize user interaction.

For the visualization a silhouette rendering process is applied in order to visualize the volumetric medical imaging dataset such that the vessel walls are visualized at least partially in a transparent fashion. In the silhouette rendering process a predetermined decay is applied. When the decay value is too low, the vessel walls are not visualized in a transparent fashion, i.e. the outside surface of the vessels are visualized in a solid fashion. On the other hand, when the decay value is too high, portions of the vessel walls are no longer visible. Therefore, at 240, a suitable silhouette decay value for the silhouette rendering process is determined such that the vessel walls and the contrast agent are visualized at least partially in a transparent fashion.

At 250, the volumetric medical imaging dataset is then rendered using the silhouette rendering process with the above determined transfer function and silhouette decay value. For example, the silhouette rendering process is executed as a gradient rendering process using off-the-shelf Graphics Processing Units (GPU) on a personal computer or workstation.

A user is then enabled to select a first viewing direction. Upon receipt of data indicative of the first viewing direction the processor generates—at 260—first vessel display data by processing the rendered volumetric medical imaging dataset in dependence upon the data indicative of the first viewing direction which are then displayed—at 270—using a graphical display. Optionally, the first vessel display data are generated such that they contain graphical data indicative of luminance of the vessel walls. For example, the graphical data indicative of luminance are generated such that the luminance changes with depth of a location of the vessel walls within the volumetric medical imaging dataset in the first viewing direction, providing a user with a better depth orientation of the vessels.

Optionally, in case the volumetric medical imaging dataset has been generated using a contrast agent, a range of intensity values of the voxels of the volumetric medical imaging dataset is determined with the range being indicative of the contrast agent. Second vessel display data are then generated for visualizing the contrast agent and blended with the first vessel display data for display. For example, the first vessel display data are generated using the above silhouette rendering process while the second vessel display data are generated using a different rendering process without silhouette mode or the above silhouette rendering process with a different silhouette decay value allowing the visualization of the contrast agent in a more opaque fashion while the vessel walls are visualized in a substantially transparent fashion.

FIG. 9 illustrates the same view and close-up as FIGS. 7a and 7b but with the dataset being rendered using the other method for visualizing a volumetric medical imaging dataset according to the invention. As shown in FIG. 9, the vessel walls are clearly visualized in a partially transparent fashion.

Numerous other embodiments of the invention will be apparent to persons skilled in the art without departing from the spirit and scope of the invention as defined in the appended claims.

What is claimed is:

1. A method for visualizing a volumetric medical imaging data set comprising:
receiving the volumetric medical imaging dataset, the volumetric medical imaging dataset being indicative of at least a vessel being imaged using a contrast agent;
providing a first and a second range of intensity values of voxels of the volumetric medical imaging dataset, the first range of intensity values being indicative of a wall of the at least a vessel and the second range of intensity values being indicative of the contrast agent;
providing a transfer function for mapping one of colors and grey scale levels to the determined first and second range of intensity values;
providing a silhouette decay value such that the vessel walls and the contrast agent are simultaneously visible;
rendering the volumetric medical imaging dataset using a first silhouette rendering process in dependence upon the transfer function and the silhouette decay value;
receiving data indicative of a first viewing direction;
generating first vessel display data by processing the rendered volumetric medical imaging dataset in dependence upon the data indicative of a first viewing direction; and,
using a graphical display, displaying the first vessel display data.

2. A method for visualizing a volumetric medical imaging data set as defined in claim 1 comprising determining a histogram of the intensity values of the voxels of the volumetric medical imaging dataset.

3. A method for visualizing a volumetric medical imaging data set as defined in claim 2 wherein the first and the second range of intensity values is provided by selecting corresponding areas in the histogram.

4. A method for visualizing a volumetric medical imaging data set as defined in claim 2 comprising:
displaying the histogram; and,
receiving from a user interface range input data indicative of the first and the second range of intensity values.

5. A method for visualizing a volumetric medical imaging data set as defined in claim 1 comprising:
determining a preset first and second range of intensity values; and,
displaying the preset first and second range of intensity values.

6. A method for visualizing a volumetric medical imaging data set as defined in claim 5 wherein the preset first and second range of intensity values are determined empirically.

7. A method for visualizing a volumetric medical imaging data set as defined in claim 5 wherein the preset first and second range of intensity values are determined based on parameters of the imaging system, the contrast agent, and the vessel wall.

8. A method for visualizing a volumetric medical imaging data set as defined in claim 4 comprising receiving from the user interface decay value input data indicative of the silhouette decay value.

9. A method for visualizing a volumetric medical imaging data set as defined in claim 8 comprising:
determining a preset silhouette decay value; and,
displaying the preset silhouette decay value.

10. A method for visualizing a volumetric medical imaging data set as defined in claim 9 wherein the preset silhouette decay value is determined empirically.

11. A method for visualizing a volumetric medical imaging data set as defined in claim 4 comprising receiving from the user interface transfer function input data indicative of a relation of the one of colors and grey scale levels to the determined first and second range of intensity values.

12. A method for visualizing a volumetric medical imaging data set as defined in claim 1 comprising:
receiving data indicative of a second viewing direction;
generating second vessel display data by processing the rendered volumetric medical imaging dataset in dependence upon the data indicative of a second viewing direction; and,
using a graphical display, displaying the second vessel display data.

13. A method for visualizing a volumetric medical imaging data set as defined in claim 1 wherein the first vessel display data are generated such that they contain graphical data indicative of luminance at least one of the vessel walls and the contrast agent.

14. A method for visualizing a volumetric medical imaging data set as defined in claim 13 wherein the graphical data indicative of luminance are generated such that the luminance changes with depth of a location of the at least one of the vessel wall and the contrast agent within the volumetric medical imaging dataset in the first viewing direction.

15. A method for visualizing a volumetric medical imaging data set as defined in claim 1 comprising:
receiving data indicative of a volumetric subset of the volumetric medical imaging dataset;
generating the volumetric subset based on the volumetric medical imaging dataset and the data indicative of the volumetric subset;
rendering the volumetric subset using the first silhouette rendering process in dependence upon the transfer function and the silhouette decay value;
generating first vessel display subset data by processing the rendered volumetric subset in dependence upon the data indicative of the first viewing direction; and,
using a graphical display, displaying the first vessel display subset data.

16. A method for visualizing a volumetric medical imaging data set as defined in claim 15 comprising:
receiving data indicative of a second viewing direction;
generating second vessel display subset data by processing the rendered volumetric subset in dependence upon the data indicative of the second viewing direction; and,
using a graphical display, displaying the second vessel display subset data.

17. A method for visualizing a volumetric medical imaging data set as defined in claim 1 comprising generating second vessel display data by rendering the volumetric medical imaging dataset using a second other rendering process providing a second other type of visualization.

18. A method for visualizing a volumetric medical imaging data set as defined in claim 17 comprising:
receiving data indicative of a volumetric subset of the volumetric medical imaging dataset;
generating the volumetric subset based on the volumetric medical imaging dataset and the data indicative of the volumetric subset;
rendering the volumetric subset using the first silhouette rendering process in dependence upon the transfer function and the silhouette decay value;
generating first vessel display subset data by processing the rendered volumetric subset in dependence upon the data indicative of the first viewing direction; and,
using a graphical display, displaying the first vessel display subset data.

19. A method for visualizing a volumetric medical imaging data set comprising:
receiving the volumetric medical imaging dataset, the volumetric medical imaging dataset being indicative of at least a vessel;
providing a range of intensity values of voxels of the volumetric medical imaging dataset, the range of intensity values being indicative of a wall of the at least a vessel;
providing a transfer function for mapping one of colors and grey scale levels to the determined range of intensity values;
providing a silhouette decay value such that the vessel walls are visualized at least partially in a transparent fashion; and,
rendering the volumetric medical imaging dataset using a first silhouette rendering process in dependence upon the transfer function and the silhouette decay value, wherein vessel walls are visible within the rendered volumetric medical imaging dataset.

20. A method for visualizing a volumetric medical imaging data set as defined in claim 19 comprising:
receiving data indicative of a first viewing direction;
generating first vessel display data by processing the rendered volumetric medical imaging dataset in dependence upon the data indicative of a first viewing direction; and,
using a graphical display, displaying the first vessel display data.

21. A method for visualizing a volumetric medical imaging data set as defined in claim 19 comprising:
determining the range of intensity values of voxels of the volumetric medical imaging dataset for being provided, the range of intensity values being indicative of a wall of the at least a vessel.

22. A method for visualizing a volumetric medical imaging data set as defined in claim 19 comprising:
determining a second range of intensity values of voxels of the volumetric medical imaging dataset, the second range of intensity values being indicative of a contrast agent;
determining a second transfer function for mapping one of colors and grey scale levels to the determined second range of intensity values;
rendering the volumetric medical imaging dataset using the second transfer function;
generating second vessel display data by processing the rendered volumetric medical imaging dataset in dependence upon the data indicative of a first viewing direction;
blending the first vessel display data and the second vessel display data;
using a graphical display, displaying the blended first and second vessel display data.

23. A method for visualizing a volumetric medical imaging data set as defined in claim 22 wherein the volumetric medical imaging dataset is rendered using a second different rendering process.

24. A method for visualizing a volumetric medical imaging data set as defined in claim 22 wherein the volumetric medical imaging dataset is rendered using the first silhouette rendering process in dependence upon a received second different silhouette decay value.

25. A storage medium having stored therein executable commands for execution on a processor, the processor when executing the commands performing:
receiving the volumetric medical imaging dataset, the volumetric medical imaging dataset being indicative of at least a vessel being imaged using a contrast agent;
receiving a first and a second range of intensity values of voxels of the volumetric medical imaging dataset, the first range of intensity values being indicative of a wall of the at least a vessel and the second range of intensity values being indicative of the contrast agent;
determining a transfer function for mapping one of colors and grey scale levels to the determined first and second range of intensity values;
receiving a silhouette decay value such that the vessel walls and the contrast agent are simultaneously visible;
rendering the volumetric medical imaging dataset using a first silhouette rendering process in dependence upon the transfer function and the silhouette decay value;
receiving data indicative of a first viewing direction;
generating first vessel display data by processing the rendered volumetric medical imaging dataset in dependence upon the data indicative of a first viewing direction; and,
providing the first vessel display data.
